(19) United States
(12) Patent Application Publication
(10) Pub. No.: US 2014/0337377 A1
(43) Pub. Date: Nov. 13, 2014

(54) MANAGING SUPPORT TEAM INQUIRIES

(71) Applicant: International Business Machines Corporation, Armonk, NY (US)

(72) Inventors: Marcos Dias de Assuncao, Rio de Janeino (BR); Silvia Cristina Sardela Bianchi, Sao Paulo (BR); Marco Aurelio Stelmar Netto, Sao Paulo (BR)

(73) Assignee: International Business Machines Corporation, Armonk, NY (US)

(21) Appl. No.: 13/969,751

(22) Filed: Aug. 19, 2013

Related U.S. Application Data
(63) Continuation of application No. 13/890,656, filed on May 9, 2013.

(51) Int. Cl. G06F 17/30

(52) U.S. Cl. CPC G06F 17/30864
USPC 707/770

(57) ABSTRACT

Resolving a query received by a support team comprising a plurality of members includes inferring current activities in which the plurality of members are involved and forwarding the query to a subset of the plurality of members based on how assignment of the query is expected to affect the current activities of the subset of the plurality of members.

### CROSS REFERENCE TO RELATED APPLICATIONS

This application is a continuation of U.S. patent application Ser. No. 13/890,656, filed May 9, 2013, which is herein incorporated by reference in its entirety.

### FIELD OF THE DISCLOSURE

The present disclosure relates generally to customer support and relates more specifically to managing inquiries submitted to support teams that provide assistance to customers.

### BACKGROUND OF THE DISCLOSURE

Large service systems, such as data centers, rely on support teams to resolve incidents with clients' information technology (IT) infrastructures. Typically, a “ticket” is created when a problem on a service is identified (e.g., by a monitoring system or by a client reporting an issue). The ticket includes a description of the problem, a deadline to solve the problem, and a priority indicator. The ticket is then assigned to one or more members of the support team based on the members' expertise and availability. If the member to whom the ticket is assigned cannot solve the problem, he or she may ask for assistance from other members of the support team or simply forward the ticket to someone else.

Customer support systems associated with many other types of services (e.g., including non-IT related services) operate in a similar manner.

### SUMMARY OF THE DISCLOSURE

A tangible computer readable storage medium stores instructions which, when executed by a processor, cause the processor to perform operations for resolving a query received by a support team comprising a plurality of members, the operations including inferring current activities in which the plurality of members are involved and forwarding the query to a subset of the plurality of members based on how assignment of the query is expected to affect the current activities of the subset of the plurality of members.

In another embodiment, a system for resolving a query received by a support team comprising a plurality of members includes a database storing information relating to activities of the plurality of members and a question and answer engine coupled to the database for inferring current activities in which the plurality of members are involved, based on the information, and for forwarding the query to a subset of the plurality of members based on how assignment of the query is expected to affect the current activities of the subset of the plurality of members.

### BRIEF DESCRIPTION OF THE DRAWINGS

The teachings of the present disclosure can be readily understood by considering the following detailed description in conjunction with the accompanying drawings, in which:

FIG. 1 is a block diagram depicting one example of a system for managing support team inquiries, according to the present invention;

FIG. 2 is a flow diagram illustrating one embodiment of a method for managing support team inquiries, according to the present invention; and

FIG. 3 is a high level block diagram of the present invention implemented using a general purpose computing device.

To facilitate understanding, identical reference numerals have been used, where possible, to designate identical elements that are common to the Figures.

### DETAILED DESCRIPTION

In one embodiment, the present invention is a method and apparatus for managing support team inquiries. Embodiments of the invention enable queries to be forwarded to potential candidates (i.e., individuals who are believed capable of responding to the queries) based on the candidates' availability and expertise. In one embodiment, a candidate's availability is determined based on the computing resources, software systems, projects on which the candidate is currently working, and/or activities the candidate may be performing. Further embodiments of the invention allow candidates to select queries to address in a way that does not compromise the candidates' current work. Thus, embodiments of the present invention consider how handling a new query will affect a candidate's current activities.

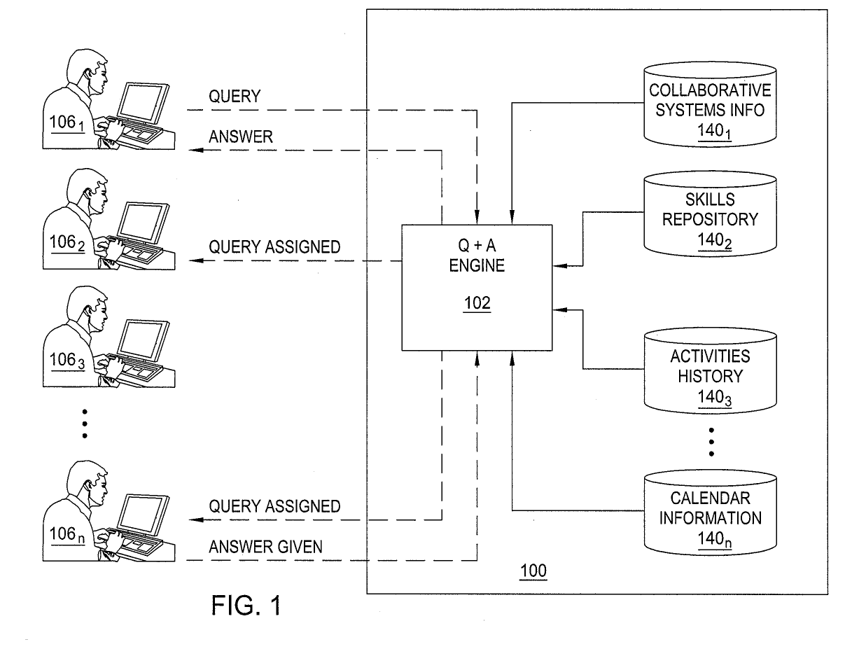

FIG. 1 is a block diagram depicting one example of a system 100 for managing support team inquiries, according to the present invention. As illustrated, the system 100 generally comprises a question and answer (Q&A) engine 102 and a plurality of databases 104₁-104ₙ (hereinafter collectively referred to as “databases 104”). The databases 104 store data relating to collaborative systems, support team members' skills, support team members' activity histories, and support team members' calendars, among potentially other data. Although FIG. 1 illustrates discrete databases for each of these types of data, it will be appreciated that a single database may store multiple different types of data, or multiple databases may be used to store just one type of data; thus, there is not necessarily a one-to-one correspondence between data types and databases. Users 106₁-106ₙ (hereinafter collectively referred to as “users 106”) may include customers and/or support team members associated with a service system.

The Q&A engine 102 operates as an input and output to the system 100. To this end, the Q&A engine 102 receives queries from individuals (e.g., customers or support team members, where a support team member may wish to forward a query to another support team member). The Q&A engine 102 also provides query answers to the individuals from whom the corresponding queries originated.

Additionally, the Q&A engine 102 makes decisions regarding assignment of queries (i.e., to which support team member(s) to assign a given query). To this end, the Q&A engine 102 receives data from the databases 104 to aid in making these decisions. The Q&A engine 102 uses the data received from the databases 104 to infer support team members' current activities (e.g., performing work on a project, fixing a server component, writing a report, solving an incident, installing software, etc.).

As discussed above, the databases 104 may include a database 104₁ that stores data relating to collaborative systems. This database 104₁ receives information from other systems (e.g., incident dispatching systems that provide information about tickets on which system administrators are working, project management systems that contain information about projects and teams, tools that support team members are currently using, etc.) that help determine on which work activities support team members are involved during certain periods of time.

The databases 104 may also include a database 104₂ that stores data relating to support team members' skills. This data may include, for example, individual support team members' work teams and knowledge levels. In one embodiment, this data is grouped by activity type and skill.

The databases 104 may also include a database 104₃ that stores data relating to support team members' activity histories. This data includes, for example, historical data about the types of activities performed by individual support team members over given periods of time. In one embodiment, this data specifically includes information about activity types (e.g., projects or tickets), support team members that performed the activities, dates and times spent on the activities (e.g., work shifts, days, years), software used to perform the activities, and/or resources on which support team members worked.

The databases 104 may also include a database 104₃ that stores data relating to support team members' calendars. This data may include, for example, information about individual support team members' schedules (e.g., details of meetings, appointments, vacations, etc.).

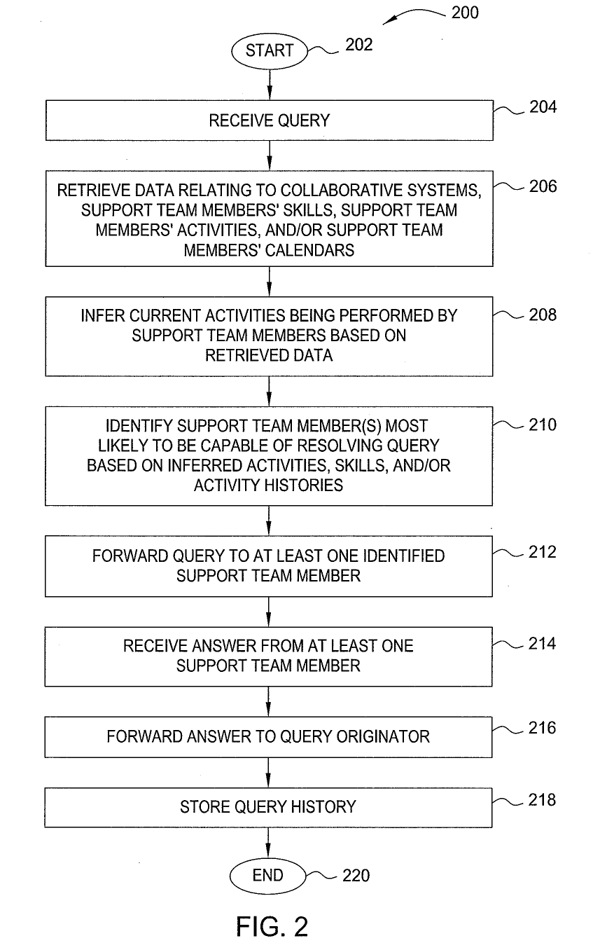

FIG. 2 is a flow diagram illustrating one embodiment of a method 200 for managing support team inquiries, according to the present invention. The method 200 may be implemented, for example, by the system 100 illustrated in FIG. 1. As such, reference is made in the discussion of the method 200 to various components of the system 100 illustrated in FIG. 1. Such reference is made for illustrative purposes only and does not limit the method 200 to implementation by the system 100. For instance, in an alternative embodiment, use of a peer-to-peer network may allow certain communications (e.g., answers to queries) to be forwarded directly by users 106 without the intervention of components of the system 100.

The method 200 begins in step 202. In step 204, the Q&A engine 102 receives a query from a user. For instance, FIG. 1 illustrates a query originating with user 106₁.

In step 206, the Q&A engine 102 retrieves data relating to collaborative systems, support team members' skills, support team members' activity histories, and/or support team members' calendars. As illustrated in FIG. 1, this data is retrieved from the databases 104.

In step 208, the Q&A engine 102 infers the current activities of support team members based on the data retrieved in step 206. As discussed above, individual support team members may currently be involved in activities including, but not limited to, performing work on a project, fixing a server component, writing a report, solving an incident, and/or installing software. In one embodiment, inference of current activities is performed at the operating system level (e.g., by checking active applications, applications on which individual support team members are currently working, and/or network connections).

In another embodiment, the Q&A engine 102 sends individual support team members lists containing activities that the support team members are expected to perform over a given period of time and requests that the support team members verify their corresponding lists. These lists may rank the activities that the individual support team members are expected to be performing currently or to perform for some time. Individual support team members may modify their corresponding lists (e.g., by selecting their current activities or adding their current activities if they are not on the lists). This user-verified information may be used to refine the inferences may by the Q&A engine 102 with respect to current activities.

In step 210, the Q&A engine 102 identifies the support team member(s) who are most likely to be capable of resolving the query, based on the current activities inferred in step 208, the skills data retrieved from the databases 104, and/or the activity histories retrieved from the databases 104. In particular, the current activities, skills, and activity histories are matched to the properties of the query (e.g., type of problem, software or resources involved, related projects, etc.). The Q&A engine 102 may also estimate how long it expects each of the indentified support team members to take to answer the query, and may remove from consideration any identified support team members who are not believed to be capable of answering the query by a given deadline. In a further embodiment discussed in further detail below, the identification of support team members may also take into account the preferences of the support team members (e.g., regarding the maximum numbers of queries that the support team members wish to receive at a time, times of day during which the support team members wish to receive queries, query topics or content in which the support team members are interested).

In step 212, the Q&A engine 102 forwards the query to at least one support team member identified in step 210. For instance, FIG. 1 illustrates the query being forwarded to users 106₂ and 106ₙ. In one embodiment, any support team member to whom the query is forwarded is also notified of all other support team members (or a configurable number of other support team members) to whom the same query (or a similar query, such as a query relating to the same software) has been forwarded. This allows the support team members to whom the query has been forwarded to potentially collaborate on a resolution (thereby possibly resolving the query more quickly). In one embodiment, queries may be sorted and prioritized in the support team members' workspaces in order to facilitate collaboration. Questions from other support team members who have been most helpful in resolving queries in the past may also be prioritized in the workspace.

In step 214, the Q&A engine 102 receives an answer from at least one of the support team members to whom the query was forwarded in step 212. For instance, FIG. 1 illustrates an answer being received from user 106ₙ. The answer may be a suggested resolution of the query or the identification of another support team member who is believed to be capable of resolving the query. In the latter case, the Q&A engine 102 may forward the query to the other support team member who is identified. In one embodiment, the Q&A engine 102 may notify all the other support team members to whom the query was forward in step 212 that an answer has been received.

In step 216, the Q&A engine 102 forwards the answer to the user 106 from whom the query originated. For instance, FIG. 1 illustrates the answer being forwarded to user 106₁.

In optional step 218 (illustrated in phantom), the Q&A engine 102 stores the query history (e.g., the query, the support team member(s) who resolved the query, the activities and/or skills of the support team member(s) who resolved the query, etc.). This information may be used by the system 100 to determine patterns of different answers to the same queries or to classify queries and answers to create a best practice or tutorial for problem resolution.

The method 200 ends in step 220.

Thus, the method 200 enables queries to be forwarded to potential candidates (i.e., individuals who are believed capable of responding to the queries) based on the candidates' availability and expertise. In one embodiment, a candidate's availability is determined based on the computing resources, software systems, and/or projects on which the candidate is currently working. Thus, embodiments of the present invention consider how handling a new query will affect a candidate's current activities.

As discussed above, the identification of potential support team members to whom to send a new query may be based at least in part on the preferences of the support team members. For instance, an individual support team member may specify that she does not wish to receive more than n queries at any given time. In this case, the Q&A engine 102 may evaluate a query against such preferences. For example, either at given intervals of time or when a new query is received, the Q&A engine 102 may, for the individual support team member, sort the list of current queries by some given criteria (e.g., ascending order of support team members' current activities, descending order of query priority, descending order of query problem deadlines, queries about similar software prioritized, queries about similar projects prioritized, and/or ascending/descending order of query length). The Q&A engine 102 may then return only the first n questions on the list. In this way, the number of queries is limited according to the individual support team member's preferences in a non-arbitrary way (e.g., the queries are prioritized according to the criteria).

Other preferences that may be taken into account include the times of day during which the individual support team member wishes to receive queries, query topics or content in which the individual support team members is interested, or query priority (e.g., as defined by the system 100 or users 106). Thus, embodiments of the invention allow support team members to customize the list of queries they receive.

Embodiments of the present invention may be especially useful in data centers, where members of a support team assigned to solve problems may not be able to solve certain problems individually. The solutions disclosed herein can be used to facilitate better collaboration among support team members and speed problem resolution. Alternatively, embodiments of the present invention may be useful in a medical care setting (e.g., a hospital), where care providers may be able to share information or expertise in order to better diagnose or treat patients.

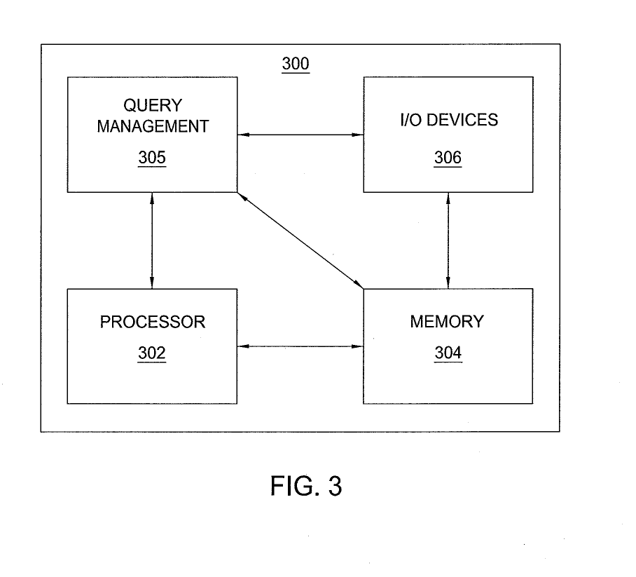

FIG. 3 is a high level block diagram of the present invention implemented using a general purpose computing device 300. In one embodiment, the general purpose computing device 300 is deployed as a question and answer engine, such as the Q&A engine 102 illustrated in FIG. 1. It should be understood that embodiments of the invention can be implemented as a physical device or subsystem that is coupled to a processor through a communication channel. Therefore, in one embodiment, a general purpose computing device 300 comprises a processor 302, a memory 304, a query management module 305, and various input/output (I/O) devices 306 such as a display, a keyboard, a mouse, a modem, a microphone, speakers, a touch screen, an adaptable I/O device, and the like. In one embodiment, at least one I/O device is a storage device (e.g., a disk drive, an optical disk drive, a floppy disk drive).

Alternatively, embodiments of the present invention (e.g., query management module 305) can be represented by one or more software applications (or even a combination of software and hardware, e.g., using Application Specific Integrated Circuits (ASIC)), where the software is loaded from a storage medium (e.g., I/O devices 306) and operated by the processor 302 in the memory 304 of the general purpose computing device 300. Thus, in one embodiment, the query management module 305 for managing support team inquiries described herein with reference to the preceding Figures can be stored on a tangible or non-transitory computer readable medium (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

Although various embodiments which incorporate the teachings of the present invention have been shown and described in detail herein, those skilled in the art can readily devise many other varied embodiments that still incorporate these teachings.

What is claimed is:

1. A tangible computer readable storage medium that stores instructions which, when executed by a processor, cause the processor to perform operations for resolving a query received by a support team comprising a plurality of members, the operations comprising:
inferring current activities in which the plurality of members are involved; and
forwarding the query to a subset of the plurality of members based on how assignment of the query is expected to affect the current activities of the subset of the plurality of members.

2. The tangible computer readable storage medium of claim 1, wherein the inferring comprises:
retrieving data relating to the plurality of members; and
determining activities in which the plurality of members are expected to be involved, based on the data.

3. The tangible computer readable storage medium of claim 2, wherein the data comprises information about collaborative systems.

4. The tangible computer readable storage medium of claim 2, wherein the data comprises information about individual skills or expertise of the plurality of members.

5. The tangible computer readable storage medium of claim 2, wherein the data comprises individual activity histories of the plurality of members.

6. The tangible computer readable storage medium of claim 2, wherein the data comprises individual calendars of the plurality of members.

7. The tangible computer readable storage medium of claim 2, wherein the data comprises operating system level data about applications currently being used by the plurality of members.

8. The tangible computer readable storage medium of claim 2, wherein the operations further comprise:
sending to the plurality of members individual lists of the activities; and
receiving from the plurality of members verification of the individual lists.

9. The tangible computer readable storage medium of claim 1, wherein the forwarding comprises:
identifying, for a given member in the subset of the plurality of members, a preference with respect to assignment of queries; and
confirming that the forwarding respects the preference.

10. The tangible computer readable storage medium of claim 9, wherein the preference specifies a maximum number of queries that the given member wishes to receive at a time.

11. The tangible computer readable storage medium of claim 9, wherein the preference specifies time of day during which the given member wishes to receive queries.

12. The tangible computer readable storage medium of claim 9, wherein the preference specifies a topic or content of queries which the given member wishes to receive.

13. The tangible computer readable storage medium of claim 9, wherein the preference specifies a priority of queries which the given member wishes to receive.

14. The tangible computer readable storage medium of claim 1, wherein the forwarding comprises:
identifying a deadline for the query; and
confirming that the subset of the plurality of members is expected to provide an answer to the query by the deadline.

15. The tangible computer readable storage medium of claim 1, wherein the forwarding comprises:
notifying each member of the subset of the plurality of members of other members in the subset of the plurality of members.

16. The tangible computer readable storage medium of claim 1, wherein the forwarding comprises:
notifying each member of the subset of the plurality of members of other members of the plurality of members who are working on similar queries.

17. The tangible computer readable storage medium of claim 1, wherein the operations further comprise:
receiving an answer to the query from at least one of the subset of the plurality of members; and
forwarding the answer to an originator of the query.

18. The tangible computer readable storage medium of claim 17, wherein the operations further comprise:
storing a history of the query.

19. A system for resolving a query received by a support team comprising a plurality of members, comprising:
a database storing information relating to activities of the plurality of members; and
a question and answer engine coupled to the database for inferring current activities in which the plurality of members are involved, based on the information, and for forwarding the query to a subset of the plurality of members based on how assignment of the query is expected to affect the current activities of the subset of the plurality of members.
